(19) United States
(12) Patent Application Publication
(10) Pub. No.: US 2010/0257789 A1
(43) Pub. Date: Oct. 14, 2010

(54) SEAL FOR AN ADJUSTABLE THRESHOLD ASSEMBLY

(75) Inventor: James W. Meeks, Eaton, OH (US)

Correspondence Address: HOWARD & HOWARD ATTORNEYS PLLC, 450 West Fourth Street, Royal Oak, MI, 48067, US

(73) Assignee: QUANEX BUILDING PRODUCTS CORPORATION, Houston, TX (US)

(21) Appl. No.: 12/421,420

(22) Filed: Apr. 9, 2009

(51) Int. Cl. E06B 1/70

(52) U.S. Cl. 49/468

(57) ABSTRACT

An adjustable threshold assembly for disposition below a door includes a sill, a rail spaced from the sill and configured to be vertically adjustable relative to the sill, and a seal disposed between the rail and the sill. The seal includes a first portion and a second portion each engaging one of the sill and the rail, respectively, and a flexible intermediate portion connecting the first and second portions. The seal includes a bulb extending from the first portion and contacting the second portion. The bulb includes a first end and a second end each extending from the first portion. The bulb encloses a cavity between the first and second ends such that the bulb resiliently collapses between the rail and the sill as the rail is vertically adjusted relative to the sill to maintain contact between the bulb and the second portion.

### BACKGROUND OF THE INVENTION

1. Field of the Invention

The present invention generally relates to a seal for an adjustable threshold assembly to maintain sealing contact between a sill and a rail that is vertically adjustable relative to the sill.

2. Description of the Related Art

A threshold assembly is mounted in a door opening of a building below a door to seal along a bottom edge of the door. The threshold assembly can be vertically adjustable to properly seal to the bottom of the door, i.e., an adjustable threshold assembly.

Adjustable threshold assemblies include a sill and a rail spaced from the sill and configured to be vertically adjustable relative to the sill. The height of the rail relative to the sill and the base can be adjusted to seal between the rail and a bottom edge of the door. Specifically, if the rail is too low relative to the bottom edge of the door then an unwanted space exists between the rail and the bottom edge of the door thereby creating the potential for water, draft, and dirt, etc., to enter the building between the rail and the door. To the contrary, if the rail is too high relative to the bottom edge of the door then excessive force is required to close the door over the rail. The adjustable threshold assembly can be selectively raised or lowered to avoid these problems.

Adjustable threshold assemblies include a seal extending from the sill to the rail to seal against water, draft, and dirt, etc. The seal prevents water, dirt, etc., from collecting below the rail and the sill, which can damage underlying structure such as that made of wood. The seal also prevents water from ultimately traveling from the exterior to the interior of the building. However, water, dirt, etc., can collect in and along the seal, which can lead to damage and rotting of the seal and which is aesthetically unappealing. There remains an opportunity to improve the seal for better sealing between the rail and the sill and for better deflection of water, dirt, etc., away from the seal.

### SUMMARY OF THE INVENTION AND ADVANTAGES

The present invention includes a seal for an adjustable threshold assembly. The adjustable threshold assembly has a sill and a rail spaced from the sill and configured to be vertically adjustable relative to the sill. The seal comprises a first portion for engaging one of the sill and the rail, a second portion spaced from the first portion for engaging the other of the sill and the rail, an intermediate portion connecting the first and second portions and being flexible relative to the first and second portions, and a bulb extending from the first portion and contacting the second portion. The bulb includes a first end and a second end each extending from the first portion with the bulb enclosing a cavity between the first and second ends such that the bulb resiliently collapses between the rail and the sill as the rail is vertically adjusted relative to the sill to maintain contact between the bulb and the second portion.

The bulb deflects water, dirt, etc., to prevent the water, dirt, etc., from collecting on the intermediate portion between the first and second portions. The seal resiliently collapses for improved sealing between the rail and the sill. In other words, because the bulb resiliently collapses, the bulb is flexible and the shape of the bulb can be distorted as the rail is vertically adjusted relative to the sill such that the bulb maintains contact with the second portion. By maintaining contact with the second portion, the bulb prevents water, dirt, etc., from collecting between the first and second portions of the seal thereby preventing damage, rot, unappealing appearance, etc., associated with collection of water, dirt, etc., between the first and second portions.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an adjustable threshold assembly disposed below a door assembly;

FIG. 2 is a cross-sectional perspective view of the adjustable threshold assembly including a sill, a rail, and a seal disposed between the seal and the rail;

FIG. 3 is a cross-sectional side view of the seal in a free position;

FIG. 4 is a cross-sectional side view of the adjustable threshold assembly with the rail at a typical preset vertical height relative to the sill;

FIG. 5 is a cross-sectional side view of the adjustable threshold assembly with the rail raised vertically from the preset position of FIG. 4 to a maximum vertical height;

FIG. 6 is a cross-sectional side view of the adjustable threshold assembly with the rail lowered vertically from the preset position of FIG. 4 to a minimum vertical height;

FIG. 7 is a cross-sectional side view of the adjustable threshold assembly with the rail raised to a maximum vertical height after being lowered from a maximum height;

FIG. 8 is a magnified view of a portion of FIG. 5; and

FIG. 9 is a cross-sectional side view of an alternative embodiment of the adjustable threshold assembly with the rail at a typical preset vertical height relative to the sill.

### DETAILED DESCRIPTION OF THE INVENTION

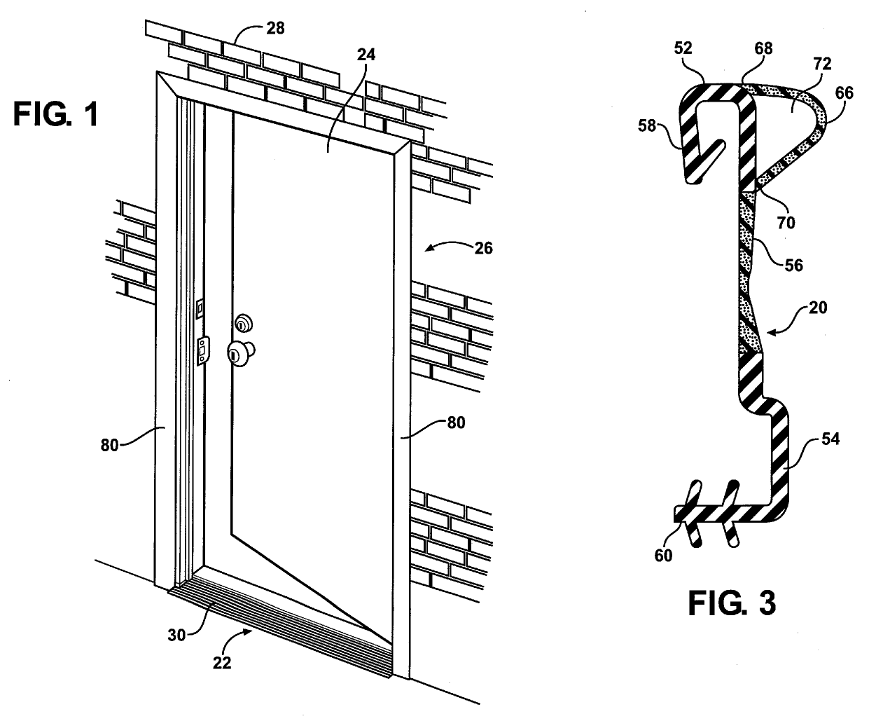

Referring to the Figures, wherein like numerals indicate like parts throughout the several views, the present invention includes a seal 20 for an adjustable threshold assembly 22. As shown in FIG. 1, the adjustable threshold assembly 22 is mounted below a door 24 of a door assembly 26 of a building 28, such as a commercial or residential building. The door assembly 26 is typically an exterior door, i.e., separating an interior of the building from an exterior of the building. It should be appreciated that, while the adjustable threshold assembly 22 is shown below a single hinged door in FIG. 1, the adjustable threshold assembly 22 can be disposed below any sort of door assembly, such as a hinged double-door assembly, i.e., French doors, a sliding door assembly, etc.

As shown in FIG. 2, the adjustable threshold assembly 22 includes a sill 30 and a rail 32 spaced from the sill 30 and configured to be vertically adjustable relative to the sill 30. The rail 32 is spaced from the sill 30 in that at least a portion of the rail 32 is spaced from the sill 30 with the seal 20 disposed in the space between the sill 30 and the rail 32, i.e., the sill 30 can contact the rail 32 away from the seal 20 without departing from the nature of the present invention. The adjustable threshold assembly 22 also includes a base 34 that is typically mounted to a floor of the building 28. The base 34 supports the sill 30 and the rail 32. The sill 30 is typically made of aluminum and slopes downwardly to shed water away from the building 28.

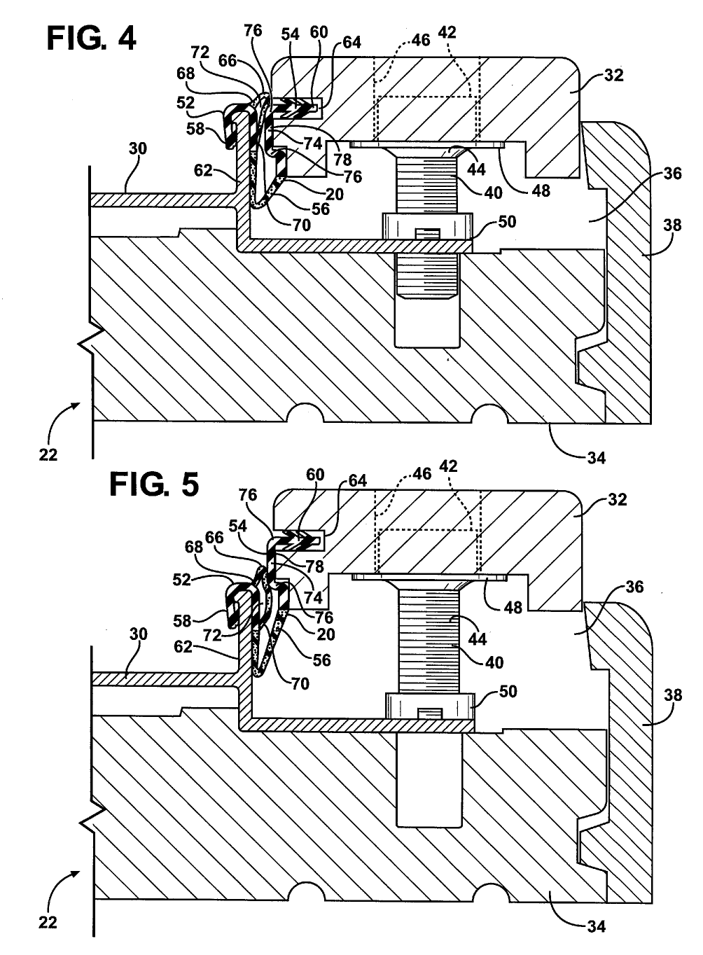

As shown in FIGS. 4-7, the height of the rail 32 relative to the sill 30 and the base 34 can be adjusted to seal between the rail 32 and a bottom edge of the door 24. If the rail 32 is too low relative to the bottom edge of the door 24 then an unwanted space exists between the rail 32 and the bottom edge of the door 24 thereby creating the potential for water, draft, and dirt, etc., to enter the building 28 between the rail 32 and the door 24. To the contrary, if the rail 32 is too high relative to the bottom edge of the door 24 then excessive force is required to close the door 24 over the rail 32. The height of the rail 32 relative to the sill 30 and the base 34 is typically adjusted after the adjustable threshold assembly 22 is mounted to the floor below the door 24.

As shown in FIG. 2, the base 34 defines a channel 36 extending longitudinally along the base 34. The sill 30 also typically forms part of the channel 36. The base 34 can, for example, include a decorative trim 38 that partially defines the channel 36. The rail 32 is disposed longitudinally along the base 34 above the channel 36.

At least one threaded fastener 40 is vertically retained by the rail 32. In other words, the rail 32 prevents vertical movement of the threaded fastener 40 relative to the rail 32 and allows rotational movement of the threaded fastener 40 relative to the rail 32.

As shown in the Figures, the rail 32 typically defines a plurality of holes 46 spaced longitudinally along the rail 32 and a threaded fastener 40 is disposed in each hole 46. Each threaded fastener 40 typically includes a head 42 and a shaft 44. The rail 32 is counter-bored around each hole 46 and the head 42 is disposed in the counter-bored hole 46. A retainer 48 engages the threaded fastener 40 for vertically retaining the threaded fastener 40 in the hole 46. The retainer 48 is typically press fit onto the shaft 44 to prevent vertical movement of the threaded fastener 40 relative to the rail 32 while allowing the threaded fastener 40 to rotate relative to the rail 32. The head 42 is typically configured to receive a tool, e.g., a screwdriver, for rotating the threaded fastener 40 relative to the rail 32.

The threaded fastener 40 is threadedly engaged with at least one of the base 34 and the sill 30 for vertically adjusting the rail 32 relative to the sill 30. In the configuration shown in the Figures, the sill 30 includes an internally threaded coupling 50 in which the threaded fastener 40 is threadedly engaged. As the threaded fastener 40 is rotated, the threaded fastener 40 moves vertically relative to the sill 30 thereby vertically adjusting the rail 32 relative to the sill 30. It should be appreciated that the threaded fastener 40, the base 34, and the sill 30 can be configured in any manner such that the rail 32 is vertically adjustable relative to the sill 30 and the base 34 without departing from the nature of the present invention. For example, the base 34 can include additional components for threadedly engaging the threaded fastener 40. In one such configuration, the base 34 can define a cutout and can include nuts rotationally retained in the cutout and threadedly receiving the threaded fasteners 40. One such example of this configuration is that shown in U.S. patent application Ser. No. 11/183,510 to Pepper et al., now published as United States Patent Application Publication No. 2006/0112644.

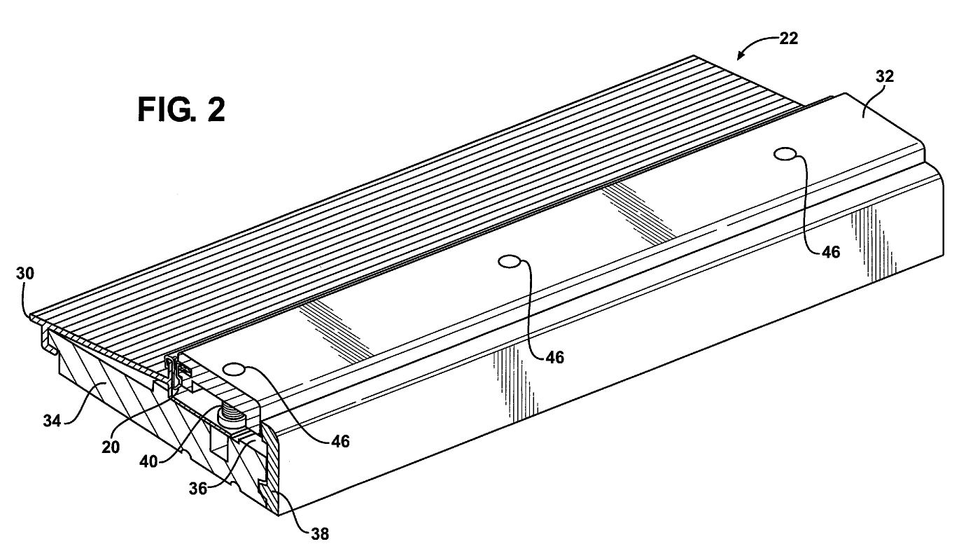

As best shown in FIG. 3, the seal 20 includes a first portion 52, 52′, a second portion 54, and an intermediate portion 56 connecting the first and second portions 54. The seal 20 is shown in a free position in FIG. 3, in which the intermediate portion 56 is flat. The seal 20 is shown in FIGS. 2 and 4-7 assembled in the adjustable threshold assembly 22 such that the intermediate portion 56 is bent. The intermediate portion 56 typically includes a thin area to urge the intermediate portion 56 to bend at the thin area when assembled in the adjustable threshold assembly 22. When assembled in the adjustable threshold assembly 22, the first and second portions 52/52′, 54 are spaced from each other.

The first portion 52, 52′ of the seal 20 engages one of the sill 30 and the rail 32 and the second portion 54 of the seal 20 engages the other of the sill 30 and the rail 32. In the configuration shown in the Figures, the first portion 52, 52′ engages the sill 30 and the second portion 54 engages the rail 32; however, it should be appreciated that this configuration is shown for exemplary purposes and can the first portion 52, 52′ can engage the rail 32 and the second portion 54 can engage the sill 30. The seal 20 includes a first seal end 58, 58′ engaging the sill 30 and a second seal end 60 engaging the rail 32.

As best shown in FIGS. 4-8, the sill 30 presents a vertical extension 62 extending longitudinally along the sill 30 and the rail 32 defines a groove 64 extending longitudinally along the rail 32. The first seal end 58 of the seal 20 is U-shaped and receives the vertical extension 62 and is typically engaged to the vertical extension 62 in a press-fit relationship. Alternatively, as shown in FIG. 9, the sill 30 presents a slot 82 and the first seal end 58′ extends into and engages the slot 82.

The second seal end 60 of the seal 20 is straight and is received in the groove 64 of the rail 32 and is typically engaged in the groove 64 in a press-fit relationship. The first seal end 58/58′ and the second seal end 60 can, for example, have barbs that deform to engage the vertical extension 62 and the groove 64, respectively. It should be appreciated that the shape of the first and second seal ends 58/58′, 60 and the type of engagement of the seal 20 with the sill 30 and the rail 32 are described herein and shown in the Figures for exemplary purposes and the seal 20 can engage the sill 30 and the rail 32 in any fashion without departing from the nature of the present invention.

The intermediate portion 56 is flexible relative to the first portion 52, 52′ and the second portion 54. As shown in FIGS. 4-7, the intermediate portion 56 flexes when the rail 32 is vertically adjusted relative to the sill 30. The first portion 52, 52′ and second portion 54 is typically formed of a common material and for example, are typically formed of a plastic such as a thermoplastic polymer, e.g., polypropylene. The intermediate portion 56 is typically formed of a rubbery material such as a thermoplastic elastomer. However, it should be appreciated that the first, second, and intermediate portions 52/52′, 54, 56 can be formed of any type of material such that the intermediate portion 56 is flexible relative to the first and second portions 52/52′, 54 without departing from the nature of the present invention. It should also be appreciated that in addition to, or in the alternative to, material selection, the thickness of the first, second, and intermediate portions 52/52′, 54, 56 can be designed such that the intermediate portion 56 is flexible relative to the first and second portions 52/52′, 54.

A bulb 66 extends from the first portion 52, 52′ of the seal 20 and contacts the second portion 54 of the seal 20. The bulb 66 seals against the second portion 54 to prevent water, dirt, etc. from settling on the intermediate portion 56 between the first and second portions 52/52′, 54 of the seal 20. Such dirt and water settled in the intermediate portion 56 would lead to rotting and/or cracking of the intermediate portion 56 and would give the adjustable threshold assembly 22 an unattractive appearance. To the contrary, the bulb 66 provides an attractive appearance to the adjustable threshold assembly 22 by covering the space between the first and second portion 54. It is also advantageous to prevent water from settling on the intermediate portion 56 because such water could leak between ends of the seal 20 and door jambs 80 of the door assembly 26 if the ends of the seal 20 are not adequately sealed to the door jambs 80.

The bulb 66 includes a first end 68 and a second end 70 each extending from the first portion 52, 52′ with the bulb 66 enclosing a cavity 72 between the first and second ends 68, 70. In other words, bulb 66 extends from the first end 68 to the second end 70 and the bulb 66 is hollow. In the configuration shown in the Figures, the cavity 72 is defined by the bulb 66 and the first portion 52, 52′ of the seal 20. In other words, first and second ends 68, 70 are spaced from each other at the first portion 52, 52′. It should be appreciated that, alternatively, the first and second ends 68, 70 of the bulb 66 could intersect one another such that the cavity 72 is defined solely by the bulb 66 without departing from the nature of the present invention. In such a configuration, the first and second ends 68, 70 could intersect one another at the first portion 52, 52′ of the seal 20 or could intersect one another spaced from the first portion 52, 52′ of the seal 20 and be connected to the first portion 52, 52′ of the seal 20 by a connecting piece.

At least one of the first and second ends 68, 70 of the bulb 66 is fixed to the first portion 52, 52′. Typically both the first and the second ends 68, 70 of the bulb 66 are fixed to the first portion 52, 52′. The bulb 66 is typically co-extruded with the first portion 52, 52′ such that the bulb 66 integrally extends from the first portion 52, 52′. However, the first end 68 and/or the second end 70 can be fixed to the first portion 52, 52′ in any fashion without departing from the nature of the present invention.

The bulb 66 is flexible relative to at least one of the first and second portions 52/52′, 54. The bulb 66 is typically formed of the same type of material as the intermediate portion 56 and is typically formed of a rubbery material such as a thermoplastic elastomer. However, it should be appreciated that the bulb 66 can be formed of a different type of material than the intermediate portion 56 and can be formed of any type of material such that the bulb 66 is flexible relative to at least one of the first and second portion 52/52′, 54 without departing from the nature of the present invention.

As shown in FIGS. 4-7, the bulb 66 resiliently collapses between the rail 32 and the sill 30 as the rail 32 is vertically adjusted relative to the sill 30 to maintain contact between the bulb 66 and the second portion 54. In other words, as the rail 32 is moved relative to the sill 30, the bulb 66 is deformed and typically continues to define the cavity 72, which changes shape as the bulb 66 deforms. Because the bulb 66 is hollow, the bulb 66 is flexible and the shape of the bulb 66 can be distorted, i.e., the bulb 66 collapses, as the rail 32 is vertically adjusted relative to the sill 30 such that the bulb 66 maintains contact with the second portion 54. In the configuration shown in the Figures, the bulb 66 is semi-cylindrical in a free state to define the cavity 72 as semi-cylindrical in shape and arcuately deforms when subjected to forces. However, it should be appreciated that the bulb 66 can be of any shape in the free state and can deform in any shape while maintaining contact with the second end 70 without departing from the nature of the present invention.

The second portion 54 includes a projection 74 and the bulb 66 contacts the second portion 54 at the projection 74. The projection 74 extends toward the first portion 52, 52′ to engage the bulb 66. The bulb 66 is typically flexible relative to the projection 74 such that the projection 74 deforms the bulb 66.

The projection 74 typically includes a corner 76 and a vertically extending portion 78 extending from the corner 76. In the configuration shown in the Figures, the projection 74 includes a pair of corners 76 with the vertically extending portion 78 extending from one of the pair of corners 76 to the other of the pair of corners 76. As the rail 32 is adjusted relative to the sill 30, the bulb 66 maintains contact with at least one of the corners 76 and the vertically extending portion 78. It should be appreciated that the vertically extending portion 78 need not extend exactly vertically and can instead have merely a vertical component to its direction of extension as well as a horizontal component to its direction of extension.

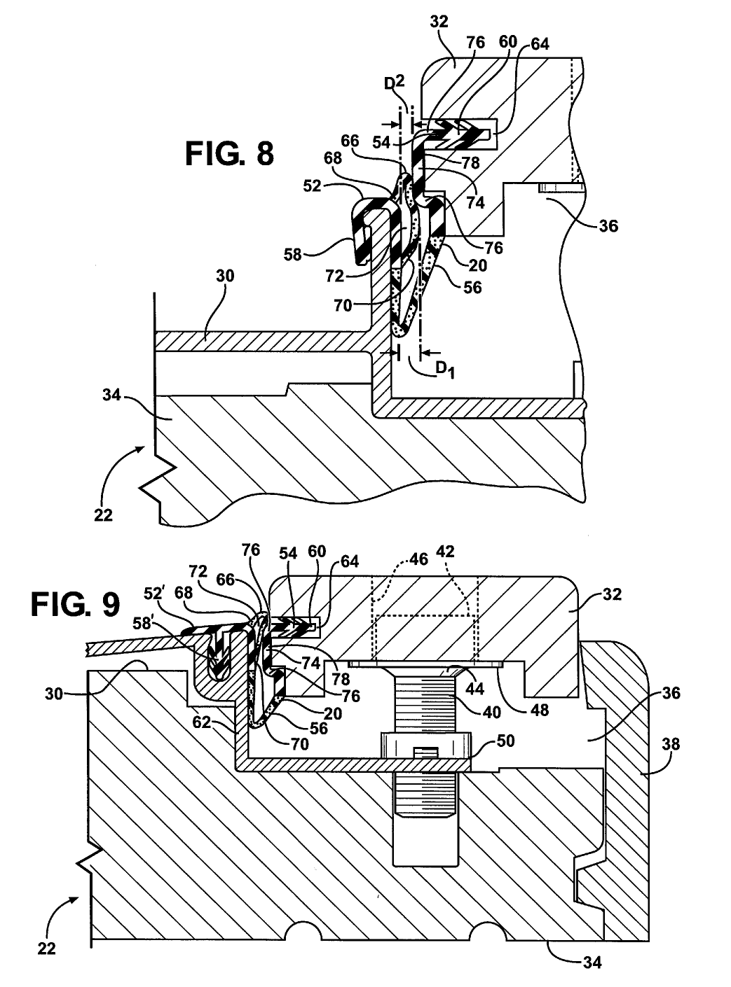

The projection 74 is spaced a first distance D1 from the first portion 52, 52′ and the bulb 66 extends toward the second portion 54 further than the first distance D1. In other words, the bulb 66 extends beyond the projection 74 to overlap the projection 74. As shown in the Figures, the bulb 66 bulges around one of the corners of the projection 74 depending upon the height of the rail 32 relative to the sill 30. As best shown in the magnified view in FIG. 8, the bulb 66 extends from the first portion 52 toward the second portion 54 a second distance D2 and the second distance D2 is greater than the first distance D1. FIG. 8 is a magnified view of a portion of FIG. 5 to clearly show the first distance D1 and the second distance D2; however, it should be appreciated that, although not labeled, the second distance D2 is greater than the first distance D1 in FIGS. 4, 6, and 7.

The rail 32 is typically assembled to the adjustable threshold assembly 22 at a preset height, such as that shown in FIG. 4. At the preset height shown in FIG. 4, the bulb 66 bulges around the upper corner 76 of the pair of corners of the projection 74. The rail 32 can be raised or lowered relative to the preset height and is usually raised or lowered after the adjustable threshold assembly 22 is installed below the door assembly 26 such that the required height to properly seal 20 to the bottom edge of the door 24 is known.

The rail 32 can be adjusted between a maximum height and a minimum height. After installation of the adjustable threshold assembly 22 below the door assembly 26, the rail 32 can be adjusted from the preset height to the maximum height, as shown in FIG. 5. As the rail 32 is adjusted upwardly, the projection 74 slides upwardly along the bulb 66 and the bulb 66 deforms about the projection 74 to maintain contact with the projection 74. At the maximum height shown in FIG. 5, the bulb 66 bulges around the lower corner 76 of the pair of corners of the projection 74.

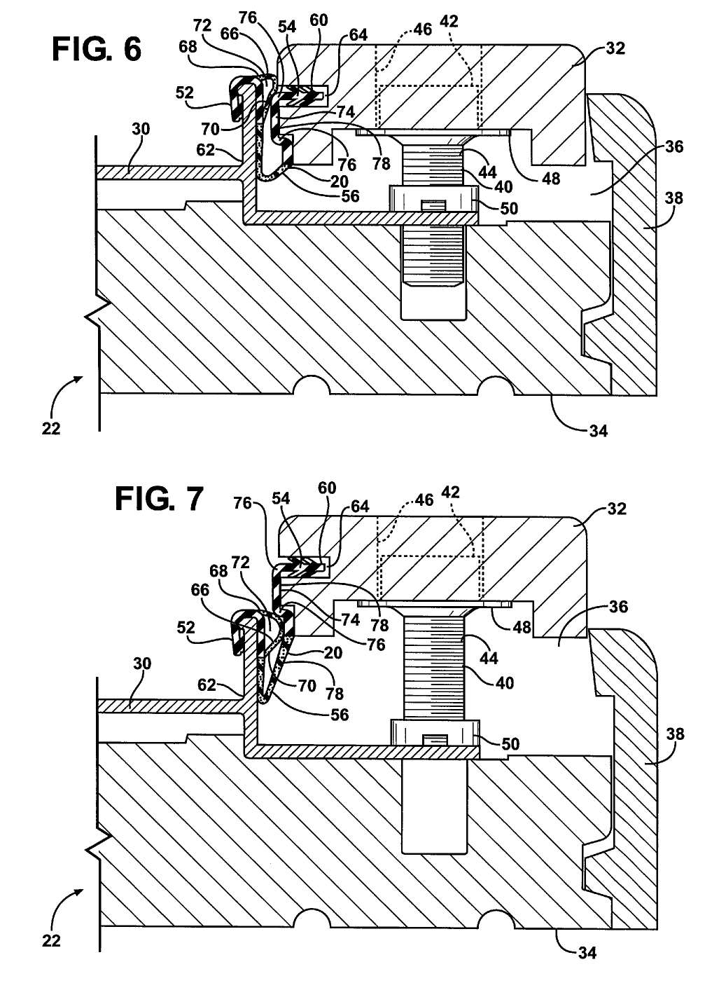

The rail 32 can also be adjusted to the minimum height from the preset height, as shown in FIG. 6. As the rail 32 is adjusted downwardly, the projection 74 slides downwardly along the bulb 66 and the bulb 66 deforms about the projection 74 to maintain contact with the projection 74. At the minimum height shown in FIG. 6, the bulb 66 bulges around the upper corner 76 of the pair of corners of the projection 74.

The bulb 66 maintains contact with the projection 74 regardless of how many times the rail 32 is adjusted upwardly and downwardly. FIG. 7 shows the position of the bulb 66 after the rail 32 is adjusted to the maximum height, then to the minimum height, and finally back to the maximum height. Even after such adjustment, the bulb 66 maintains contact with the projection 74. Specifically, the bulb 66 bulges slightly around the lower corner 76 of the pair of corners of the projection 74.

Notably, as set forth above, the bulb 66 deforms by collapsing. The bulb 66 collapses because the bulb 66 is hollow and the cavity 72 is able to deform when sufficient force is applied to the bulb 66. Such collapse allows for constant, consistent, and relatively impermeable sealing between the bulb 66 and the projection 74. In addition, because the bulb 66 is hollow, the bulb 66 is able to roll relative to the first portion 52, 52′ as the rail 32 slides along the bulb 66.

The seal 20 is typically formed by co-extrusion such that the first portion 52, 52′, second portion 54, intermediate portion 56, and bulb 66 are co-extruded together. However, it should be appreciated that the seal 20 can be formed in any fashion without departing from the nature of the present invention.

The door jambs 80 extend upwardly relative to the floor of the building 28 with the adjustable threshold assembly 22 extending between the door jambs 80. A flexible sealant is typically swiped across both ends of the seal 20 such that the flexible sealant contacts the jambs 80 to seal the seal 20 to the jambs 80. The flexible sealant flexes to maintain sealing contact between the seal 20 and the jambs 80 as the rail 32 is vertically adjusted relative to the sill 30. The flexible sealant can be, for example, a wet sealant, i.e., a sealant that is applied while wet. For example, the sealant can be acrylic caulk or silicone. The flexible sealant is also typically applied to ends of the sill 30 to seal the sill 30 to the jambs 80.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. An adjustable threshold assembly for disposition below a door, said adjustable threshold assembly comprising:
a sill;
a rail spaced from said sill and configured to be vertically adjustable relative to said sill; and
a seal comprising:
a first portion engaging one of said sill and said rail;
a second portion engaging the other of said sill and said rail;
an intermediate portion connecting said first and second portions and being flexible relative to said first and second portions; and
a bulb extending from said first portion and contacting said second portion;
wherein said bulb includes a first end and a second end each extending from said first portion with said bulb enclosing a cavity between said first and second ends such that said bulb resiliently collapses between said rail and said sill as said rail is vertically adjusted relative to said sill to maintain contact between said bulb and said second portion.

2. The adjustable threshold assembly as set forth in claim 1 wherein said bulb is flexible relative to at least one of said first and second portions.

3. The adjustable threshold assembly as set forth in claim 1 wherein at least one of said first and second ends of said bulb is fixed to said first portion.

4. The adjustable threshold assembly as set forth in claim 1 wherein said cavity is defined by said bulb and said first portion of said seal.

5. The adjustable threshold assembly as set forth in claim 1 wherein said second portion includes a projection and said bulb contacts said second portion at said projection.

6. The adjustable threshold assembly as set forth in claim 5 wherein said bulb is flexible relative to said projection.

7. The adjustable threshold assembly as set forth in claim 5 wherein said projection is spaced a first distance from said projection and said bulb extends toward said second portion further than said first distance.

8. The adjustable threshold assembly as set forth in claim 5 wherein said projection includes a corner and a vertically extending portion extending from said corner.

9. The adjustable threshold assembly as set forth in claim 5 wherein said projection includes a pair of corners with said vertically extending portion extending from one of said corners to the other of said corners.

10. The adjustable threshold assembly as set forth in claim 1 further including a base supporting said sill and a threaded fastener vertically retained by said rail and threadedly engaged with at least one of said base and said sill for vertically adjusting said rail relative to said sill.

11. The adjustable threshold assembly as set forth in claim 1 wherein at least one of said first and second ends of said bulb is fixed to said first portion, wherein said second portion includes a projection and said bulb contacts said second portion at said projection, wherein said bulb is flexible relative to said projection, and wherein said projection is spaced a first distance from said first portion and said bulb extends toward said second portion further than said first distance.

12. A seal for an adjustable threshold assembly wherein the adjustable threshold assembly has a sill and a rail spaced from the sill and configured to be vertically adjustable relative to the sill, said seal comprising:
a first portion for engaging one of the sill and the rail;
a second portion spaced from said first portion for engaging the other of the sill and the rail;
an intermediate portion connecting said first and second portions and being flexible relative to said first and second portions; and
a bulb extending from said first portion and contacting said second portion;
wherein said bulb includes a first end and a second end each extending from said first portion with said bulb enclosing a cavity between said first and second ends such that said bulb resiliently collapses between the rail and the sill as the rail is vertically adjusted relative to the sill to maintain contact between said bulb and said second portion.

13. The seal as set forth in claim 12 wherein said bulb is flexible relative to at least one of said first and second portions.

14. The seal as set forth in claim 12 wherein at least one of said first and second ends of said bulb is fixed to said first portion.

15. The seal as set forth in claim 12 wherein said cavity is defined by said bulb and said first portion of said seal.

16. The seal as set forth in claim 12 wherein said second portion includes a projection and said bulb contacts said second portion at said projection.

17. The seal as set forth in claim 16 wherein said bulb is flexible relative to said projection.

18. The seal as set forth in claim 16 wherein said projection is spaced a first distance from said first portion and wherein said bulb extends toward said second portion further than said first distance.

19. The seal as set forth in claim 16 wherein said projection includes a corner and a vertically extending portion extending from said corner.

20. The seal as set forth in claim 19 wherein said projection includes a pair of corners with said vertically extending portion extending from one of said corners to the other of said corners.

21. The seal as set forth in claim 12 wherein at least one of said first and second ends of said bulb is fixed to said first portion, wherein said second portion includes a projection and said bulb contacts said second portion at said projection, wherein said bulb is flexible relative to said projection, and wherein said projection is spaced a first distance from said first portion and said bulb extends toward said second portion further than said first distance.
